(19) United States
(12) Patent Application Publication
(10) Pub. No.: US 2017/0022079 A1
(43) Pub. Date: Jan. 26, 2017

(54) ANOXIC SUBMERGED ATTACHED GROWTH REACTOR FOR DENITRIFICATION OF WASTEWATER

(71) Applicant: Nelson Environmental Inc., Winnipeg (CA)

(72) Inventors: Martin Hildebrand, Winnipeg (CA); Merle Kroeker, Winnipeg (CA); Byron Heppner, Winnipeg (CA)

(21) Appl. No.: 15/061,155

(22) Filed: Mar. 4, 2016

Related U.S. Application Data
(60) Provisional application No. 62/129,111, filed on Mar. 6, 2015.

(51) Int. Cl. C02F 3/28

(52) U.S. Cl. CPC C02F 3/2806; C02F 2101/163

(57) ABSTRACT

Described herein is an anoxic submerged attached growth reactor which provides for removal of nitrate from wastewater as well as the process and/or method for using the reactor. Denitrifying bacterial grow on a support media within the reactor, and remove the nitrates from the wastewater. The reaction is carried out under anoxic conditions without agitation. Excess denitrifying bacterial release from the support media and collect at the bottom of the reactor.

### PRIOR APPLICATION INFORMATION

The instant application claims the benefit of U.S. Provisional Patent Application 62/129,111 filed Mar. 6, 2015, entitled ANOXIC SUBMERGED ATTACHED GROWTH REACTOR FOR DENITRIFICATION OF WASTEWATER, the contents of which are incorporated herein by reference.

### BACKGROUND OF THE INVENTION

Wastewater is generally defined as any domestic, municipal or industrial liquid waste.

Compounds such as organic matter and nitrogen contained in wastewater are capable of being oxidized and transformed by bacteria which use these compounds as a food source. Typically, heterotrophic bacteria digest the organic matter while nitrifying bacteria digest the non-carbon compounds, for example, oxidizing ammonia to nitrate (a process known as nitrification to those skilled in the art).

Influent into the wastewater treatment lagoon will typically be raw wastewater, CBOD 150-250 mg/l; TSS 150-250 mg/l; total Kjeldahl Nitrogen (TKN) 25-45 mg/l; ammonia 20-40 mg/l; and total phosphorus 6-8 mg/l.

Effluent from a wastewater treatment lagoon typically has estimated concentrations of CBOD5 20-40 mg/l; total suspended solids (TSS) 20-40 mg/l; and TKN of approximately 15-45 mg/l.

Following nitrification of the wastewater to convert ammonia into nitrates, the nitrates can be denitrified to nitrogen gas.

Nitrate (NO₃⁻)→Nitrite (NO₂⁻)→Nitric Oxide (NO)→Nitrous Oxide (N₂O)→N₂ gas

Denitrification must take place under conditions where oxygen, a more energetically favorable electron acceptor, is near or at depletion.

In some wastewater treatment methods and systems, a carbon source, for example, methanol, ethanol, acetate, glycerin or the like is added to the wastewater as a food source for the denitrifying bacteria.

### SUMMARY OF THE INVENTION

According to an aspect of the invention, there is provided a method for denitrifying wastewater comprising:

providing a reactor comprising: an inlet for receiving wastewater containing nitrates; an outlet for releasing treated wastewater from the reactor; a base; sidewalls extending upwardly from the base; and a top, said top having a cover for enclosing the reactor, said cover being arranged to prevent air from entering the reactor so that anoxic conditions are maintained within the reactor, said cover further being arranged to permit CO₂ and N₂ gases generated within the reactor to exit the reactor via the cover;

providing a quantity of bacterial growth support media within the reactor, said bacterial growth support media comprising denitrifying bacteria thereon;

adding wastewater comprising nitrates and a suitable carbon source for denitrifying bacterial growth to the reactor via the inlet, the denitrifying bacteria converting wastewater comprising nitrates and the carbon source into denitrified waste water and CO₂ and N₂ gases;

wherein during cell division of the denitrifying bacteria, a portion of the denitrifying bacteria grow away from the bacterial growth support media and release from the bacterial growth support media, thereby collecting at the base of the reactor for removal.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

As used herein, ‘heterotrophic bacteria’ refers to bacteria capable of utilizing organic material. It is of note that genera of such bacteria are well known within the art and one of skill in the art will understand that this refers to specific bacteria of this type known to be present in for example treatment lagoons.

As used herein, denitrifying bacteria refers to bacteria capable of converting nitrate to nitrogen gas. It is of note that such bacteria are well known within the art and one of skill in the art will understand that this refers to specific bacteria of this type known to be present in for example treatment lagoons. However, exemplary examples include but are by no means limited to heterotrophic bacteria such as for example Paracoccus denitrificans and various pseudomonads and/or autotrophic denitrifiers such as for example Thiobacillus denitrificans.

As used herein, “winter months” or “cold weather months” or “cold months” refers to months in which the water temperature approaches 10° C.

As used herein, “warm weather months” or “warm months” refers to months in which the water temperature is typically considerably higher than 10° C.

Described herein is an anoxic submerged attached growth reactor which provides for removal of nitrate from wastewater as well as the process and/or method for using the reactor.

The invention is used in combination with, that is, is supplied nitrified wastewater. For example, the nitrified wastewater may be supplied by the method described in U.S. Pat. No. 8,083,944 or U.S. Pat. No. 6,200,469 or by other suitable processes that provide nitrified wastewater for denitrification known to those of skill in the art. It is of note that while the reactor and method of using the reactor described herein may be used in cold to moderate climates, this is not necessarily an essential aspect of the invention. That is, while the reactor will function in climates that experience cold weather months, the reactor will also function in climates that do not experience cold weather months.

Specifically, as discussed herein, the Anoxic Submerged Attached Growth Reactor comprises an anoxic attached growth vessel which receives a treated wastewater which has undergone nitrification, that is, in which a significant portion, for example, substantially all of the ammonia has been converted to nitrate. The reactor receives this wastewater containing nitrates and converts the nitrate therein to nitrogen gas, which bubbles out of the system, thereby removing nitrates from the wastewater, as discussed below.

As discussed herein, in a preferred embodiment, the anoxic submerged attached growth reactor comprises a tank, a lagoon, or a retention pond. As discussed above, the reactor has an inlet from which wastewater containing nitrates is transferred or added to the reactor.

Preferably, the reactor has a cover which is arranged to prevent atmospheric oxygen, for example, air in the form of wind, from entering the reactor so that anoxic conditions are maintained within the reactor. Furthermore, the cover is arranged such that N₂ and CO₂ gases evolved during denitrification exit the reactor.

For example, in one embodiment the cover is fabricated from panels of synthetic plastic sheeting (for example 30 mil HDPE). In other embodiments, the cover may further comprise an insulating foam panel enclosed by the panels of plastic sheeting. In some embodiments, the joints between cover panels may be permeable to allow precipitation (i.e. rain) to drain through the cover and for evolved gases (i.e. nitrogen and carbon dioxide) to vent through the cover, as discussed herein.

Accordingly, in some embodiments, the cover comprises a plurality of panels of plastic sheeting, each respective one of the panels being connected to at least one other panel by a permeable joint. As discussed above, the panels are impermeable and prevent the entry of air into the reactor. However, the joints are permeable and allow water such as rain that falls on the cover to enter the reactor. Furthermore, the joints also allow gases evolved within the reactor such as N₂ and CO₂ to exit the reactor.

The reactor comprises a quantity of at least one natural or synthetic bacterial growth substrate media selected from the group consisting of but not limited to: natural aggregate (rock or stone); natural or synthetic cloth media; natural or synthetic fibres, ropes, or threads; flexible synthetic geomembrane material sheets; plastic growth media, which may be either randomly distributed or assembled into a structure; rigid natural or synthetic media sheets; and combinations thereof. Specifically, the bacterial growth substrate media is arranged to be flowable, that is, so that wastewater can flow through the bacterial growth substrate media. As will be appreciated by one of skill in the art, the bacterial growth substrate media must provide a surface on which the bacteria can grow and must also be flowable so that wastewater can flow therethrough so that the denitrification bacteria have access to the nitrates in the wastewater, as discussed below.

As discussed herein, in a preferred embodiment, the bacterial growth support media comprises a plurality of sheets which are arranged to hang downwardly from the top of the reactor. As discussed above, the sheets are not connected at a bottom edge thereof to the base of the reactor. As a result of this arrangement, the sheets are more “flowable”, that is, allow the wastewater to better flow through and around the sheets so that the nitrate in the wastewater is made more available to the denitrification bacteria growing on the sheets.

Furthermore, this arrangement means that the reaction within the reactor can be carried out without agitation as the denitrification bacteria grow on the suspended surfaces of the sheets and the wastewater containing nitrates and carbon flows through the sheets, thereby providing a food source for the denitrification bacteria. A significant advantage of this arrangement is that, as discussed above, as the bacterial biofilm thickness grows past a certain point, the weight of the biomass will overcome the shear strength of the attachment between the biofilm and the media and excess biomass is released therefrom, and falls to the bottom of the reactor, where it forms a sludge which can be removed from the reactor as necessary. Because the biomass settles to the bottom of the basin, it does not obstruct water flow through the reactor, or obstruct contact between the wastewater and biomass growing on the media substrate. The thickness of the mature biofilm will depend on system operational characteristics, and will range between 1 and 10 mm.

Thus, as discussed herein, the Anoxic Submerged Attached Growth Reactor provides denitrification of wastewater using attached growth media suspended in a reactor. The wastewater enters the reactor and is distributed in order to achieve full use of the reactor volume and avoid hydraulic short-circuiting. No mechanical mixing or agitation is provided within the bed, although as will be appreciated by one of skill in the art, there is mixing provided by the flow of wastewater from inlet to outlet.

As discussed below, non-turbulent flow within the reactor allows sloughed bacterial solids to settle to the bottom of the reactor. As a result of this arrangement, the amount of suspended solids in the effluent is not increased.

In some embodiments, a portion of the effluent from the ANSAGR reactor may be recycled to the inlet of the reactor in order to improve treatment efficiency. This recycle flow rate may vary between 0 and 20 times the nominal system flow rate.

In some embodiments, the spacing between the media sheets may vary between 4″ and 24″, with the spacing as a function of incoming concentration of nitrates to be denitrified. That is, for higher nitrate concentrations, the distance between sheets is reduced so that the reactor can accommodate more sheets. As will be apparent to one of skill in the art, this means that more denitrifying bacteria will be supported within the reactor which in turn means more denitrification.

The sheets may be suspended at a top portion of each respective sheet on a support structure such that the sheets hang downward, as discussed above. Specifically, the support structure is arranged to be proximal to a top of the reactor, so that on removal of the cover, the respective sheets can be accessed for examination, cleaning and/or removal. In a preferred embodiment, the support structure is arranged to float on the surface of the wastewater within the reactor.

In preferred embodiments, the bottoms of the respective sheets are not connected to a bottom or base of the reactor or pond; however, the bottoms of the respective sheets may comprise weights or ballast which acts to weigh down the bottom edge of each respective sheet so that the sheet hangs downwardly into the reactor or pond. Thus, in a preferred embodiment, the media is configured such that it can be removed and replaced without dewatering the basin, that is, removing all wastewater from the reactor (i.e. all mounting connections are accessible from the water surface upon removal of the cover).

It is important to note that the sheets may not necessarily be flat but may include indentations and protrusions, thereby supplying additional surface area on which the denitrifying bacteria may grow. As a result of this arrangement, many more denitrifying bacteria are capable of growing on these sheets than would grow on a flat sheet as a result of this additional surface area.

As will be appreciated by one of skill in the art, in some embodiments, endogenous decay of sludge and other biomass within the reactor may be sufficient to support growth of the denitrifying bacteria that may serve as the carbon source. In many embodiments, denitrification will require supplemental carbon addition to support denitrifying bacteria growth. In these embodiments, a supplemental carbon source is supplied, for example but by no means limited to: methanol; ethanol; glycerine; glycol; food waste; food processing waste; acetate; proprietary products known in the art manufactured as a supplemental carbon source for wastewater treatment; and combinations thereof.

Supplemental carbon is dosed continuously in proportion to the incoming nitrate level. In some preferred embodiments, a commercial glycerine-based product is used for cold month applications. In some embodiments, nitrate levels in the incoming wastewater, that is, wastewater that is about to be added to the reactor, are measured so that supplemental carbon can be dosed at the correct level to support denitrification of the wastewater.

As will be appreciated by one of skill in the art, the exact ratio of carbon to nitrogen may vary considerably depending on the nitrate content of the waste and the growth conditions but in some embodiments a suitable ratio may be 3-20 mg/L carbon to 1 mg/L nitrogen.

In some embodiments, effluent BOD/COD levels may be monitored to prevent excessive addition of supplemental carbon. In these embodiments, the effluent BOD is maintained within a suitable range, wherein if effluent BOD is above the upper limit of the desired range, less carbon is added and if the effluent BOD is below the lower limit of the desired range, more carbon is added, as discussed above. In some embodiments, a suitable range of effluent BOD may be between 10-60 mg/L.

In use, wastewater containing nitrates is added to the reactor. As discussed above, the bacterial growth substrate media is flowable which means that as wastewater is added, the wastewater flows through the hanging sheets, such that denitrifying bacteria growing on the bacterial substrate growth media have access to and can use the nitrate and carbon source for respiration and growth. As the bacteria grow and divide on the bacterial growth substrate media, some bacteria will no longer be in direct contact with the bacterial growth substrate media and will be released therefrom. These released bacteria fall to the bottom or base of the reactor and will form a sludge in the base or bottom of the reactor which may be removed by any of a variety of means known in the art, for example, suction piping, scrapers, or by using a de-sludging barge.

As will be appreciated by one of skill in the art, the sludge does not need to be removed daily but rather can be removed as necessary.

In use, there is provided a reactor comprising: an inlet for receiving wastewater containing nitrates; an outlet for releasing treated wastewater; a base; sidewalls extending upwardly from the base; and a top.

As discussed above, the top has a cover for enclosing the reactor. The cover is arranged to prevent air from entering the reactor so that anoxic conditions are maintained within the reactor. That is, air in the form of wind is kept out of the reactor by the cover so that anoxic conditions are maintained. However, as discussed above, the cover is semi-permeable so that rainwater does not accumulate on the cover and passes through the cover and into the reactor. The cover is also arranged so that CO₂ and N₂ gases generated within the reactor during the denitrifying process exit the reactor via the cover.

As discussed above, there is provided a quantity of bacterial growth support media within the reactor which comprises denitrifying bacteria growing thereon.

As discussed herein, wastewater comprising nitrates is added to the reactor via the inlet. Specifically, in some embodiments, the level of incoming nitrates in the wastewater being added to the reactor is measured or monitored so that an appropriate quantity of a suitable carbon source can be added, as discussed above.

The nitrates within the wastewater and the carbon source are used by the denitrifying bacteria for growth. Specifically, as discussed above, the denitrifying bacteria convert the wastewater comprising nitrates into denitrified waste water and CO₂ and N₂ gases.

As discussed herein, while growing, at least a portion of each denitrifying bacteria remains in contact with the bacterial growth support media.

As discussed above, in some embodiments, the bacterial growth support media comprise a plurality of sheets arranged to hang downward from the top of the reactor to the base of the reactor via a support structure. This arrangement permits access to the sheets from the top of the reactor so that on removal of the cover of the reactor, the individual sheets can be accessed and/or removed if necessary.

In some embodiments, the individual sheets are not connected to the base of the reactor but rather include weights or ballast or are otherwise arranged so that the sheets depend downwardly from the top of the reactor.

The sheets are also arranged to be flowable so that wasterwater can flow through the sheets so that the denitrifying bacteria growing on the bacterial growth support media have access to the nitrates in the wastewater.

It is important to note that the process within the reactor is anoxic and is also carried out without active mixing or agitation aside from what is caused by addition of the wastewater to the reactor. Accordingly, there is provided the proviso that the method or reaction is carried out in the absence of active agitation and/or added agitation.

As a result of this arrangement, the denitrifying bacteria are able to grow on the bacterial growth support media. As discussed above, as the denitrifying bacteria grow and divide, the denitrifying bacteria form a biofilm on the bacterial growth support media. Some cells will lose contact with the bacterial growth support media and will fall away therefrom and will collect at the base of the reactor. As discussed above, these bacteria form a sludge which is subsequently removed from the reactor.

The denitrified wastewater or effluent exits the reactor via the outlet. As discussed above, the BOD of the effluent is measured so that adjustments can be made to the growth conditions within the reactor.

As will be apparent to one of skill in the art, the above described method and system for wastewater denitrification is a continuous process wherein wastewater comprising nitrates is added to the reactor via the inlet while denitrified effluent exits via the outlet. As discussed herein, in some embodiments, a portion of the effluent from the ANSAGR reactor may be recycled to the inlet of the reactor in order to improve treatment efficiency. This recycle flow rate may vary between 0 and 20 times the nominal system flow rate.

As will be appreciated by one of skill in the art, the time of residence for wastewater depends on the size of the reactor and the amount of wastewater being added as well as other factors such as rainfall. However, in most embodiments of the invention, wastewater remains in the reactor between 24 and 48 hours. The preferred detention time is 32 hours. For example, reactor depths may range from approximately 4′ to approximately 12′, although in some embodiments a preferred depth may be 8′.

As discussed above, the reaction within the reactor can be carried out without agitation as the denitrifying bacteria grow on the suspended surfaces of the growth media sheets and the wastewater containing nitrates and carbon flows through the sheets, thereby providing a food source for the denitrifying bacteria. A significant advantage of this arrangement is that, as discussed above, as the bacterial biofilm thickness grows past a certain level, the weight of the biomass will overcome the shear strength of the attachment between the biofilm and the media and excess biomass is released therefrom, and falls to the bottom of the reactor, where it forms a sludge which can be removed from the reactor as necessary. The thickness of the mature biofilm will depend on system operational characteristics, and will range between 1 and 10 mm. As discussed above, as growth of the denitrifying bacteria exceeds this film thickness, biomass in the form of denitrifying bacteria releases from the biofilm and collects at the base or bottom of the reactor.

As will be appreciated by one of skill in the art, this arrangement prevents the bacteria from building up past a certain density and also facilitates removal of sludge from the reactor. Specifically, the lack of agitation allows for the collection of the sludge at the bottom of the reactor.

Furthermore, the use of hanging sheets as bacterial support growth media means that access to the bottom of the reactor is relatively unhindered, thereby facilitating removal of the sludge. For example, sludge may be removed from the reactor once every 1-5 years, with annual removal being the preferred interval.

As discussed above, the bottom edge of the respective media sheets may include weights or ballast which prevents the sheets from floating upwards while in use, for example, from being effectively pushed upwards by or along with nitrogen gas and carbon dioxide gas evolved during the denitrification of the wastewater. The media sheets may also be constructed from materials which do not require supplemental ballast to remain submerged during operation.

While the preferred embodiments of the invention have been described above, it will be recognized and understood that various modifications may be made therein, and the appended claims are intended to cover all such modifications which may fall within the spirit and scope of the invention.

1. A method for denitrifying wastewater comprising:
providing a reactor comprising: an inlet for receiving wastewater containing nitrates; an outlet for releasing treated wastewater; a base; sidewalls extending upwardly from the base; and a top, said top having a cover for enclosing the reactor, said cover being arranged to prevent air from entering the reactor so that anoxic conditions are maintained within the reactor, said cover further being arranged to permit CO₂ and N₂ gases generated within the reactor to exit the reactor via the cover;
providing a quantity of bacterial growth support media within the reactor, said bacterial growth support media comprising denitrifying bacteria thereon;
adding wastewater comprising nitrates and a suitable carbon source for denitrifying bacterial growth to the reactor via the inlet, the denitrifying bacteria converting wastewater comprising nitrates and the carbon source into denitrified waste water and CO₂ and N₂ gases;
wherein during cell division of the denitrifying bacteria, a portion of the denitrifying bacteria grow away from the bacterial growth support media and release from the bacterial growth support media thereby collecting at the base of the reactor for removal.

2. The method according to claim 1 wherein the bacterial growth substrate media is selected from the group consisting of: natural aggregate; natural cloth media; synthetic cloth media; fibres; ropes; threads; flexible synthetic geomembrane material sheets; plastic growth media; rigid natural media sheets; rigid synthetic media sheets; flowable media sheets; and combinations thereof.

3. The method according to claim 1 with the proviso that the wastewater is denitrified in the absence of active agitation.

4. The method according to claim 1 wherein the reactor is a tank, lagoon or retention pond.

5. The method according to claim 1 wherein the reactor further comprises a support structure proximal to the top of the reactor.

6. The method according to claim 5 wherein the bacterial growth support media comprises a plurality of flowable sheets and each respective sheet hangs from the support structure downward into the reactor.

7. The method according to claim 6 wherein the flowable sheets include a weight or ballast proximal to a bottom end thereof.

8. The method according to claim 6 wherein the flowable sheets comprise indentations and protrusions for increasing surface area thereof.

9. The method according to claim 1 wherein the suitable carbon source is selected from the group consisting of: methanol; ethanol; glycerine; glycol; food waste; food processing waste; acetate; and combinations thereof.
